(19) United States
(12) Patent Application Publication
(10) Pub. No.: US 2008/0309502 A1
(43) Pub. Date: Dec. 18, 2008

(54) Method and Device for Detecting Forest Fires

(75) Inventors: Henri Boccia, Belcodene (FR); Philippe Patrice, Marseille (FR)

Correspondence Address: BUCHANAN, INGERSOLL & ROONEY PC, POST OFFICE BOX 1404, ALEXANDRIA, VA, 22313-1404, US

(73) Assignee: SMART PACKAGING SOLUTIONS (SPS), Rousset (FR)

(21) Appl. No.: 12/092,983

(22) PCT Filed: Oct. 25, 2006
(86) PCT No.: PCT/FR2006/002417

§ 371 Date: Jul. 24, 2008

(30) Foreign Application Priority Data
Nov. 10, 2005 (FR) 0511491

(51) Int. Cl. G08B 17/10; G08B 17/12

(52) U.S. Cl. 340/578; 340/539.1; 340/584; 340/632

(57) ABSTRACT

The invention relates to a method of detecting a fire in a wooded area. Some trees in the area are provided with a fire sensor having a radiofrequency emitter able to emit information for identifying and/or locating each sensor, according to a grid of the area to be monitored. At each fire sensor, the fire absent or fire present state is detected A fire sensor emits an alert signal to a monitoring post if a fire is present in the vicinity of the sensor. The alert signal contains information for identifying and/or locating the sensor. The alert signal is transmitted from the monitoring post to a fire brigade by means of a long-range radiofrequency link.

The invention relates to methods and devices for detecting fires, in particular for the early detection of forest fires.

For the requirements of the present description, the term “forest” will be used to denote, in a general manner and for the sake of simplification, any outdoors area comprising vegetation that is capable of burning, it being understood that, for the purposes of the present application, the term “trees” of said forest encompasses plant species of any size and of any type.

Relatively empirical and visual methods for detecting forest fires, based on the principle of “no smoke without fire” are already known in the prior art. For instance, a first method consists in dispatching, to the area to be observed, persons charged with surveying the forest, seeing any suspect smoke and confirming the start of a fire where necessary. In actual fact, when a fire is detected rapidly, it is easier to intervene at an early stage and thus to prevent the fire from rapidly spreading and devastating hundreds of hectares of forest. This method is expensive due to the human means that are mobilised. Furthermore, it is ineffective in geographical areas which are difficult to access.

Another method which is commonly used consists in visually surveying a wooded area from an observation point which is generally placed at a height. This solution is also costly in terms of human means since, in order to cover a wide area, a plurality of observation points are required and each observation point requires a team of agents who take it in turns to survey the forest in groups of two. If smoke is detected, someone then has to be dispatched to the suspect area in order to verify whether this is indeed the start of a fire. This operation of verifying and confirming results in a loss of precious time, since it is not easy to precisely locate the area where the fire may have started. If a fire has indeed started and if there is any wind, precious time may be lost before effectively confirming the start of a fire and actually mobilising the means for combating the fire. On the other hand, it is not possible from an economic point of view to send substantial means for combating the fire before having effectively confirmed and precisely located the start of a fire.

The two known methods described above are sometimes used in combination, which increases the cost of surveillance but without guaranteeing absolute efficacy.

Furthermore, none of the known methods makes it possible to follow in a certain and effective manner the spread of a fire once the latter has started, unless aeroplane or helicopter observation means are added as well, which are particularly expensive.

One object of the invention is therefore to propose a method and a device for detecting forest fires without the disadvantages of the known methods.

Another object of the invention is to propose a method and a device for detecting and following fires automatically, which makes it possible to limit to the strictest minimum the human interventions required in the phase of surveying and detecting the start of a fire.

Another object of the invention is to propose a method and a device for detecting fires which makes it possible to detect the start of a fire very quickly, and also to locate said fire with great precision, which makes it possible to direct the first means of intervention to the site very quickly.

Another object of the invention is to propose a method and a device for detecting fires which is able to follow in real time the spread of a forest fire after it has started, including during the night.

To this end, the invention relates to a system for the early detection of the start of a forest fire, characterised in that it comprises a plurality of sensors forming a grid across the area of forest to be monitored, each sensor being able to detect locally the start of a fire and being associated with a radiofrequency transmitter which is connected via radio to a control station or terminal so that the detection of the start of a fire in the vicinity of a sensor is transmitted automatically to the control terminal, which generates an alert signal, in particular destined for the fire brigade.

Preferably, each sensor and/or each control terminal is associated with a positioning information item, in particular of the GPS (“Global Positioning System”) type, and each sensor periodically transmits an identification signal to the control terminal so that the absence of an identification signal is interpreted as a probable start of a fire at the location of the sensor or in the vicinity of the control terminal.

Advantageously, the control terminal is configured so as to transmit an alarm signal only in the event of a simultaneous absence of the identification signal from two or more neighbouring fire sensors.

It may be envisaged to obtain sufficient coverage of the area of forest to be protected with a detection system which uses between 3 and 5 sensors per hectare of forest.

According to one advantageous embodiment of the detection system, each sensor comprises an antenna made of a material which deteriorates above a predetermined temperature threshold, so that any rise in temperature in the vicinity of the sensor above the predetermined threshold causes the antenna to disappear or deteriorate and makes it impossible for the sensor to communicate with its control terminal.

According to another embodiment of the detection system, each sensor is sensitive to a gaseous component representative of the start of a fire so that, when the concentration of said gaseous component exceeds a predetermined threshold in the vicinity of a sensor, this sensor sends an alert signal to the control terminal.

It is of course possible to use sensors which combine temperature detection and gas detection.

Ideally, the sensors of the system are arranged in the trees, approximately halfway up the latter.

Other features and advantages of the invention will become apparent on reading the detailed description of the appended drawings, in which:

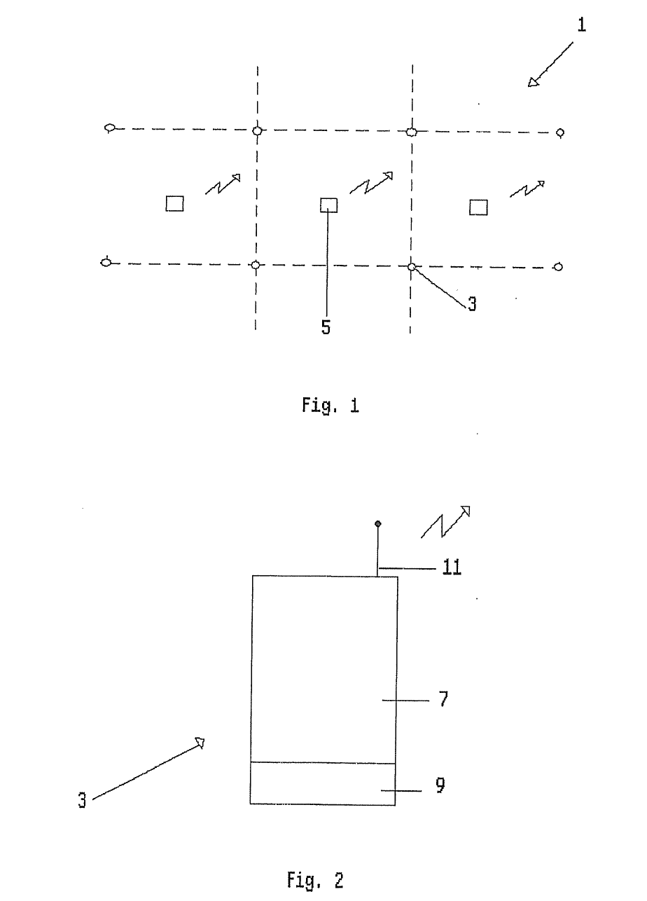

FIG. 1 shows a block diagram of the detection system according to the invention.

FIG. 2 shows a block diagram of a sensor used in the detection system of FIG. 1.

Reference is made to FIG. 1.

This figure schematically shows a system 1 for the early and automatic detection of the start of a forest fire. This system 1 comprises on the one hand a plurality of sensors 3 capable of detecting the evolution of a physical or chemical parameter, the change in which is able to indicate the start of a fire. This network of sensors 3 forms a grid across the area of forest to be monitored, with a density, that is to say a number of sensors per unit surface area, that the person skilled in the art will be capable of determining on a case-by-case basis, in particular as a function of the recurrent risk of fires starting in the area to be protected or the usual climatic conditions in the area. It will easily be understood that the choice concerning the density of the network of sensors is a compromise between the cost of the system, which increases with the number of sensors, and the environmental conditions of the area to be protected. It will thus easily be understood that the density of the network of sensors will have to be higher in a wooded area which is rather dry and often exposed to violent winds, such as the South of France or Portugal for example, and that it can be lower in a wooded area located further North. For instance, it may be determined that a detection system according to the invention is already very effective if it comprises between 3 and 5 sensors per hectare of forest, the network consisting for example of square grid cells with a sensor at each corner of a square and a control terminal in the centre of a grid cell.

It is essential for the correct functioning of the system according to the invention that the information regarding the local detection of the start of a fire by one of the sensors 3 of the system is relayed as quickly as possible to a control terminal 5 for the information from the sensors, so as to be able to generate an alert and to put in place a device for combating the fire. To this end, each sensor 3 is associated with a radiofrequency transmitter 7 which is connected preferably via radiofrequency to a nearby control terminal 5 so that the detection of the start of a fire in the vicinity of a sensor 3 is transmitted automatically to the control terminal, which then generates a long-range radiofrequency alert signal, in particular destined for the fire brigade.

In order to obtain the finest possible granularity, it would be possible to provide each sensor 3 with long-range radiofrequency transmission means, so that each sensor would itself be able to directly alert the fire brigade in the event of detecting the start of a fire. However, this solution would be quite expensive. A preferred variant of the invention is that in which the sensors 3 have a radiofrequency range of around 50 to 100 metres, which is sufficient for transmitting an identification and alert signal to a control terminal 5 located in the centre of the grid cell of sensors in question.

It is of course possible to make the sensors 3 and the control terminals 5 operate according to a positive logic, in which the state of each sensor is permanently monitored and any change in state is interpreted as the potential start of a fire. However, it is preferable to make the sensors 3 and the control terminals 5 operate according to a negative logic, in which only the stoppage of receipt of a detection signal by a control terminal 5 is signalled, along with the coordinates of the sensor or sensors 3 which have stopped transmitting. This solution has the advantage of placing the accent directly on the area in which a fire may have started.

In order to precisely locate the area in which a fire has started, it is provided that each sensor 3 comprises a unique identification which is associated with an information item regarding the positioning of the sensor (or of the closest control terminal), in particular of the GPS (“Global Positioning System”) type. It is thus sufficient if each sensor 3 transmits via radio an information item which includes its identification number, and a database makes it possible to ascertain the link between the identification of each sensor and its geographical location. Of course, it would be possible to make each sensor 3 transmit its geographical position directly, as indicated above, but this would lead to a substantially elevated cost.

Preferably, in order to extend the life of its internal battery, each sensor does not transmit continuously but rather transmits a periodic identification signal so that the absence of an identification signal for a period greater than one or several periods of the signal is interpreted as the start of a fire at the location of the sensor.

In order to reduce the risk of a false alarm, the invention provides in one variant that each control terminal is configured so as to transmit an alarm signal only in the event of a simultaneous absence of an identification signal from two or more neighbouring fire sensors. Since the probability of two or more neighbouring sensors failing at the same time is very low, this failure which is almost simultaneous or within a short time interval will make it possible to determine with very little error that the cause of the absence of a signal is in fact the start of a fire.

Reference will now be made to FIG. 2, which shows a block diagram of one of the sensors 3 used in the system according to the invention.

Each sensor 3 comprises an electronic circuit (not shown) which is supplied by a battery calculated for an autonomy of several years, which supplies a memory circuit associated with a radiofrequency transmitter 7. The memory circuit makes it possible to store the GPS location information of the sensor 3 at the time of installation of the latter. This information is converted into an analogue signal by a digital/analogue converter, which as output delivers the analogue signal to an antenna 11. In a first variant embodiment, the electronic circuit comprises a simple logic circuit which receives as input the temperature information coming from a stage 9 which acts as a temperature sensor and, when the temperature is detected as having exceeded a certain predetermined threshold, for example 70° C., the logic circuit commands the end of transmission of the radio signal destined for the control terminal 5, which corresponds to the detection of the start of a fire. In another, even simpler embodiment of the fire sensor, which omits the need for the aforementioned logic circuit, the antenna 11 is made of a material which deteriorates above a predetermined temperature threshold. As a result, any rise in temperature in the vicinity of the fire sensor 3 above the predetermined threshold causes the antenna 11 to disappear or deteriorate and makes it impossible for the sensor 3 to communicate with the associated control terminal, which will be interpreted by the control terminal and the downstream elements as the start of a fire.

Other sensor variants are possible. For instance, each sensor 3 may be designed to be sensitive to a gaseous component representative of the start of a fire, such as terpene for example, so that, when the concentration of said gaseous component exceeds a predetermined threshold in the vicinity of a sensor 3, this sensor sends an alert signal to the associated control terminal which relays it to the fire brigade.

The ideal positioning of the sensors 3 in the trees of the wooded area to be protected will be easily determined by the person skilled in the art as a function of the characteristics of the area to be protected. Ideally the sensors are arranged approximately halfway up the trees.

It should be noted that the invention makes it possible to detect, automatically and almost in real time, the start of a forest fire. The system can easily be modulated, in particular by varying the density of installation of the sensors, in order to obtain a more or less rapid detection of the start of a fire.

Furthermore, the gathering and computer monitoring of the signals indicating the presence and absence of sensors makes it possible to follow in real time the evolution of an established fire, including during the night, which allows better management of the means for combating the fire. In particular, the following in real time makes it possible to detect very quickly any change in the spread of the fire, which makes it possible to position the fire-fighters with maximum safety.

1. System for the early detection of the start of a forest fire, comprising a plurality of sensors forming a grid across the area of forest to be monitored, each sensor being able to detect locally the start of a fire and being associated with a radiofrequency transmitter which is connected via radio to a control terminal so that the detection of the start of a fire in the vicinity of a sensor is transmitted automatically to the control terminal, which generates an alert signal destined for the a fire brigade.

2. Detection system according to claim 1, wherein each sensor and/or each control terminal is associated with a positioning information item, and wherein each sensor periodically transmits an identification signal so that the absence of an identification signal is interpreted as the start of a fire at the location of the sensor.

3. Detection system according to claim 2, wherein each control terminal is configured so as to transmit an alarm signal only in the event of a simultaneous absence of an identification signal from two or more neighbouring fire sensors.

4. Detection system according to claim 3, comprising between 3 and 5 sensors and one control terminal per hectare of forest.

5. Detection system according to claim 1, wherein each sensor comprises an antenna made of a material which deteriorates above a predetermined temperature threshold, so that any rise in temperature in the vicinity of the sensor above the predetermined threshold causes the antenna to deteriorate and makes it impossible for the sensor to communicate with the control terminal.

6. Detection system according to claim 1, wherein each sensor is sensitive to a gaseous component representative of the start of a fire so that, when the concentration of said gaseous component exceeds a predetermined threshold in the vicinity of a sensor, said sensor sends an alert signal to the control terminal.

7. Detection system according to claim 1, wherein the sensors are located approximately halfway up the trees.

8. Method for detecting fire in a wooded area, comprising the following steps:
providing some trees in the area with a fire sensor which is provided with a radiofrequency transmitter capable of transmitting an information item for identifying and/or locating each sensor, in a grid across the area to be monitored;
detecting at each fire sensor a fire absent or fire present state and, in the event of the presence of fire in the vicinity of a fire sensor, making said sensor transmit an alert signal comprising an identification information item and/or a location signal for said sensor, to a control terminal; and
transmitting the alert signal from the control terminal to a fire brigade by means of a long-range radiofrequency link.

9. Method for detecting fire according to claim 8, wherein each sensor detects locally the concentration of a gas that is characteristic of the start of a fire, and wherein a given sensor transmits an alert signal to the associated control terminal as soon as the concentration of said gas exceeds a predetermined threshold in the vicinity of said sensor.

10. Method for detecting fire according to claim 8, wherein each sensor detects the temperature conditions in its vicinity, and wherein it ceases to transmit its identification signal when this temperature exceeds a predetermined threshold, so that the associated control terminal deduces therefrom the start of a fire in the vicinity of the sensor as soon as said sensor is detected as absent.
